(19) United States
(12) Patent Application Publication
(10) Pub. No.: US 2009/0038591 A1
(43) Pub. Date: Feb. 12, 2009

(54) Pre-ignition fuel treatment system

(76) Inventors: Dennis Lee, Newfoundland, NJ (US); Michael Holler, Honey Grove, PA (US)

Correspondence Address: THOMAS J. GERMINARIO, ESQ., 154 ROUTE 206, CHESTER, NJ, 07930, US

(21) Appl. No.: 12/149,961

(22) Filed: May 12, 2008

Related U.S. Application Data
(63) Continuation-in-part of application No. 11/889,226, filed on Aug. 10, 2007.

(51) Int. Cl. F02M 27/02

(52) U.S. Cl. 123/538; 123/3; 123/557

(57) ABSTRACT

A method and apparatus for reforming a hydrocarbon fuel increases its energy content, improves its combustibility and reduces combustion by-products. The hydrocarbon fuel is cracked during multiple passes through a reactor vessel by means of electrochemical interactions with a reactor rod composed of a magnetic and/or catalytic material.

### CROSS-REFERENCES TO RELATED APPLICATIONS

This application is a continuation-in-part of application Ser. No. 11/889,226, entitled “Pre-Ignition Fuel Treatment System”, by Dennis Lee, filed Aug. 10, 2007.

### BACKGROUND OF THE INVENTION

The present invention improves combustion efficiency and reduces polluting combustion by-products of internal combustion engines by reforming the hydrocarbon fuel to render it more readily and completely combustible. This is accomplished by a pre-ignition fuel treatment system in which large, complex hydrocarbon molecules are “cracked” or broken down into smaller, simpler molecules. These simpler hydrocarbons are more readily combustible and produce fewer combustion by-products. Hydrocarbon “cracking” is a highly endothermic reaction, which means it requires a large amount of energy to complete the reaction. Therefore, hydrocarbon cracking must take place under conditions of high temperature and high pressure. The cracking process is facilitated by the presence of a catalystic material and/or by an electrochemical quasi-catalytic reaction.

The present invention takes advantage of the high temperature, high pressure environment of the engine's exhaust gases to create a reaction zone in which the hydrocarbon molecules of the fuel are cracked. The hydrocarbon cracking reaction is facilitated by the insertion into the reaction zone of a reactor rod made of a magnetic material, which is preferably iron. Under the high temperature conditions of the reaction zone, the surface of the iron reactor rod becomes oxidized. It is known that iron oxides act as catalysts for various hydrocarbon cracking processes, as for example, in the hydrocarbon reforming processes taught by Setzer, et al., U.S. Pat. No. 4,451,578.

As ionized fuel molecules and atoms are produced during the cracking process, moreover, their motion around the reactor rod generates an electromagnetic field which magnetizes the iron in the rod. As the iron rod itself magnetizes, the rod generates its own magnetic field, which further ionizes the fuel and accelerates the motion of the ionized particles. These accelerated ions then generate a still stronger electromagnetic field, which in turn induces even greater magnetism in the iron rod. Thus, the electrical-magnetic interaction of the ionized fuel and the reactor rod becomes a feedback loop that drives the process toward ever greater ionization until the complex hydrocarbons in the fuel are broken down into simpler hydrocarbons, which are in a plasma state. This is an electrochemical quasi-catalytic reaction that can proceed even in the absence of a catalytic material in the reactor rod.

The “Background of the Invention” discussion of application Ser. No. 11/889,226, which is incorporated herein by reference, explains that the prior art patents in this field, and specifically Pantone, U.S. Pat. No. 5,794,601, and Jonson, U.S. Pat. No. 7,194,984, fail to provide the proper environment in the reaction zone to sustain an endothermic hydrocarbon cracking process. An important distinction between the present invention and the Pantone and Jonson patents is the total absence in the prior art of either catalytic reactor rods or an electrochemical quasi-catalytic process. Without such catalytic and/or quasi-catalytic reactions, hydrocarbon cracking simply cannot occur in the temperature range of engine exhaust gases. Consequently, the prior art fails to disclose an apparatus and process capable of cracking hydrocarbon fuel and converting it into a genuine plasma so as to truly improve the fuel's combustibility and increase the overall combustion efficiency of the internal combustion engine in which the fuel is burned.

The present invention represents an improvement over the “Pre-Ignition Fuel Treatment System” described in application Ser. No. 11/889,226, insofar as it provides for a multi-pass reaction zone. In the previous application, the fuel makes only a single pass through the reaction zone, which results in some portion of the fuel that goes to the engine remaining unreformed. This factor will limit the improvement in fuel efficiency that the invention seeks to achieve.

In the present invention, however, the fuel is re-circulated through the reaction zone in multiple passes until virtually all of the fuel is reformed. After each pass through the reaction zone, the reformed fuel components will be in a plasma state containing large numbers of anions (i.e., negatively charged ions). In order to stabilize the reformed fuel plasma, hydrogen cations (H⁺ ions) are injected downstream of the reaction zone. Still further downstream, the fuel is cooled and condensed, so that the unreformed fuel (e.g., gasoline) will revert to a liquid state, while the reformed fuel components (typically comprising methane, ethane, propane, and butane) remain in a gaseous state.

The stabilized reformed fuel gas is then stored in an auxiliary fuel tank, while the unreformed liquid fuel is collected in the main fuel tank, from where it is re-circulated back through the reaction zone, and the process is repeated in recurring cycles. From the auxiliary fuel tank, some of the reformed gaseous fuel is pumped to the engine as needed, while some of it is pumped back into the reaction zone to act as a “carrier-gas” into which atomized unreformed liquid fuel is injected. This latter step enables the present invention to avoid injecting air as a carrier-gas for the atomized fuel entering the reaction zone. The present invention thereby averts one of the principal disadvantages of the system disclosed in application Ser. No. 11/889,226, namely the potential for partial combustion of the fuel in the reaction zone due to the presence of oxygen there. Such partial combustion generates pollutants (CO and CO₂) and reduces fuel efficiency. Moreover, the exclusion of air from the reaction zone in the present invention eliminates nitrogen as well as oxygen and thereby prevents the formation of NOₓ pollutants.

Therefore, the present invention represents an improvement over the “Pre-Ignition Fuel Treatment System” described in application Ser. No. 11/889,226 by reforming a greater percentage of the fuel through use of a multi-pass reaction zone, and by eliminating partial fuel combustion and NOₓ formation within the reaction zone. The present invention also has the advantage over the prior art of producing a stabilized reformed gaseous fuel that can be stored in an auxiliary fuel tank and used as needed. The prior art, including this inventor's prior application Ser. No. 11/889,226, has no storage capability for reformed fuel and thus requires continuous operation of the fuel treatment system while the engine is running. This is particularly problematic during the initial cold start of an engine and during rapid acceleration, when the output of reformed fuel will not keep pace with the real-time fuel demand of the engine.

The reformed fuel storage capability of the present invention, on the other hand, allows the fuel treatment system of the current invention to cycle on and off as needed to maintain an adequate reserve of reformed gaseous fuel. Unlike the prior art, the present invention maintains the same high level of fuel efficiency and low level of pollutants during cold engine starting and rapid acceleration.

### SUMMARY OF THE INVENTION

It is an object of the present invention to create a reaction zone in a motor vehicle wherein the hydrocarbon fuel is reformed at high temperature and pressure, such that large hydrocarbon molecules are “cracked” to produce smaller, more readily combustible molecules.

It is another object of the present invention to take advantage of the high temperature, high pressure environment of the engine's exhaust gases by locating the reaction zone within the exhaust pipe, such that some of the energy of exhaust gases is transferred to the fuel molecules and helps induce molecular cracking.

It is a further object of the present invention to promote in the reaction zone catalytic and/or electrochemical quasi-catalytic reactions in order to facilitate the hydrocarbon cracking process and to enable that process to take place at a lower temperature and pressure than would otherwise be feasible.

It is yet another object of the present invention to utilize a reactor rod composed of a material that also has magnetic properties, such that when ions from the cracking process flow around the reactor rod, the rod becomes magnetized and generates a magnetic field which interacts with ionized hydrocarbon molecules, causing them to accelerate.

It is yet a further object of the present invention to create in the reaction zone a positive feedback loop between the magnetization of the reactor rod and the acceleration of the hydrocarbon molecules, such that the accelerated motion of the ionized molecules induces a progressively stronger magnetism in the rod, which in turn generates a stronger magnetic field that further accelerates the molecules.

It is still another object of the present invention to utilize the electromagnetic feedback loop created in the reaction zone to accelerate the hydrocarbon fuel molecules to such an elevated energy level that the reformed portion of the fuel is transformed into a plasma.

It is still a further object of the present invention to crack virtually all of the hydrocarbon fuel molecules by utilizing a multi-pass reaction zone, such that, after each pass through the reaction zone, the treated fuel is cooled and the larger unreformed hydrocarbon molecules condense into a liquid, which is then separated from the smaller reformed hydrocarbon molecules that remain in a gaseous state, with the unreformed liquid fuel being re-circulated back through the reaction zone.

It is yet one more object of the present invention to produce a stable reformed hydrocarbon fuel, which can be stored and used as needed by the engine, by injecting hydrogen cations (H⁺ ions) into the reformed fuel plasma downstream of the reaction zone, so that the hydrogen cations combine with the reformed fuel anions (e.g., CH₃⁻, CH₂⁻, C₂H₅⁻, etc.) to produce stable, neutral molecules of reformed fuel (e.g., CH₄, C₂H₆, etc.).

It is still one more object of the present invention to avoid the partial combustion of fuel in the reaction zone and the concomitant generation of pollutants (such as CO and NOₓ) by excluding air from the reaction zone and instead using a portion of the reformed gaseous hydrocarbon fuel as a “carrier-gas” into which atomized unreformed fuel is injected at the inlet end of the reaction zone.

These and other beneficial objects are achieved by a process in which a multi-pass reaction zone is established within the outflow of exhaust gases downstream of the exhaust manifold of an internal combustion engine. The reaction zone comprises a reactor vessel that is installed within the exhaust pipe, such that the exhaust gases flow around the reactor vessel on all sides. The reactor vessel is an oblong plenum formed by a rigid reactor enclosure, which is non-contiguously affixed to the exhaust pipe. Within the reactor enclosure is a reactor rod, which is axially positioned within the reactor vessel such that a uniform annular plenum is formed between the surface of the reactor rod and the walls of the reactor enclosure. The reactor rod is centrally located along the length of the reactor vessel, and it is composed of a material that has magnetic properties and preferably has catalytic properties as well.

On the inlet end of the reactor vessel is an injection assembly, comprising one or more fuel injection ports and one or more carrier-gas injection ports. The fuel injection ports are hydraulically connected to a fuel line, through which a hydrocarbon fuel flows from a main fuel tank. The carrier-gas injection ports are pneumatically connected to an auxiliary fuel tank in which gaseous reformed hydrocarbon fuel is stored.

Downstream of the outlet end of the reactor vessel is a condenser in which the partially reformed fuel is cooled, thereby causing the larger, unreformed hydrocarbon molecules to condense as a liquid, while the smaller, reformed hydrocarbon molecules remain as a gas. The unreformed liquid fuel then flows into the main fuel tank, from where it is re-circulated back through the reaction zone. Upstream of the condenser, the partially reformed fuel is injected with hydrogen cations so as to convert the reformed fuel plasma into a stable molecular state in order to facilitate storage of the reformed fuel. The stabilized reformed fuel is pumped into the auxiliary fuel tank, which is pneumatically connected to the engine's carburetor and to the carrier-gas injection ports.

The mixture of unreformed fuel and reformed carrier-gas (hereafter referred to as the “fuel-gas mixture”) flows within the reactor vessel in the opposite direction to the flow of exhaust gases around the reactor enclosure. At the distal side of this cross-flow process (i.e., the side furthest from the exhaust manifold), the fuel-gas mixture is heated by the exhaust gases to a temperature at which the unreformed fuel is completely vaporized. The vaporized fuel-gas mixture then encounters the reactor rod at its distal end, which preferably has a convex shape to promote laminar flow around it. As the vaporized fuel-gas mixture enters the annular plenum around the reactor rod, its flow path becomes constricted, which causes its pressure and velocity to increase. The increased pressure and kinetic energy of the vaporized fuel-gas mixture is further augmented by its absorption of thermal energy from the exhaust gases, which are becoming progressively hotter as the exhaust manifold is approached.

As the temperature and pressure of the vaporized fuel-gas mixture becomes progressively elevated, some of the vaporized unreformed fuel molecules reach a sufficient energy to become ionized and/or to undergo at the surface of the reactor rod catalytic cracking reactions that produce ionized molecules. The motion of the ionized fuel molecules generates an electromagnetic field around the reactor rod, and this electromagnetic field magnetizes the reactor rod itself. As the reactor rod becomes magnetized, it generates its own magnetic field which causes the motion of the ionized fuel molecules to accelerate. The accelerated motion of the ionized fuel molecules has two effects. First, the accelerated ionic flow generates a stronger electromagnetic field around the reactor rod, which causes the reactor rod to become more strongly magnetized, which then further accelerates the ionic flow. Second, the accelerated flow increases the kinetic energy of the unreformed fuel molecules, thereby increasing the temperature and pressure of the vaporized fuel, so that an increasing number of molecules undergo catalytic and/or quasi-catalytic cracking along the surface of the reactor rod.

The electrochemical quasi-catalytic cracking process occurs as follows: As more fuel molecules ionize and/or crack, more ions are produced and their increasing number and acceleration generates a progressively stronger electromagnetic field around the reactor rod. This strengthening electromagnetic field, in turn, progressively increases the magnetization of the rod. The progressively stronger magnetic field generated by the reactor rod then further accelerates the molecular flow, further increasing the kinetic energy of the molecules and causing more of them to crack and ionize.

Thus, a positive feedback loop is established which drives the hydrocarbon molecules to progressively higher kinetic energy levels. This is an endothermic process that increasingly draws energy from the cross-flow of exhaust gases as those gases become hotter toward the proximal side of the reactor vessel (i.e., the side closest to the exhaust manifold). This positive feedback loop continues until the vaporized fuel-gas mixture reaches the proximal end of the reactor rod and has been ionized to a degree corresponding to the physical state known as plasma.

The present invention represents an improvement over the “Pre-Ignition Fuel Treatment System” disclosed in application Ser. No. 11/889,226 in three principal respects:

(1) Recognizing that all of the hydrocarbon fuel molecules will not be cracked in a single pass through the reaction zone, the present invention provides a multi-pass reaction zone, through which the unreformed fuel molecules are re-circulated in multiple passes as many times as it takes to crack them. This multi-pass system assures that virtually 100% of the hydrocarbon fuel molecules will ultimately be cracked, thereby producing a reformed hydrocarbon fuel comprising smaller molecules (typically methane, ethane, propane and butane) which are more readily combustible and which generate less pollutants when combusted.

(2) Recognizing that the presence of air in the reaction zone has undesirable consequences, the present invention eliminates the use of air as a carrier-gas for the atomized fuel injected at the inlet end of the reactor vessel and instead uses a portion of the gaseous reformed fuel as a carrier-gas. This airless reaction zone excludes oxygen and nitrogen (except to the extent they are present in the fuel) and thereby prevents the partial combustion of the fuel before it gets to the engine, which reduces overall fuel efficiency. The airless reaction zone also prevents the formation of pollutants such as carbon monoxide, carbon dioxide and oxides of nitrogen.

(3) Recognizing that direct flow of the reformed fuel from the reaction zone to the engine's intake manifold will be insufficient during cold start-up and rapid acceleration, the present invention stabilizes the reformed fuel, thereby allowing it to be stored for use as needed by the engine.

### BRIEF DESCRIPTION OF THE DRAWINGS

FIG. 1 is a schematic diagram of the improved pre-ignition fuel treatment system according to the preferred embodiment of the present invention.

FIG. 2 is a cross-sectional view of the reaction zone with the reactor vessel installed in an exhaust pipe according to the preferred embodiment of the present invention.

FIG. 3 is a cross-sectional view of an alternate configuration of the reactor rod component of the present invention.

### DETAILED DESCRIPTION OF THE PREFERRED EMBODIMENT

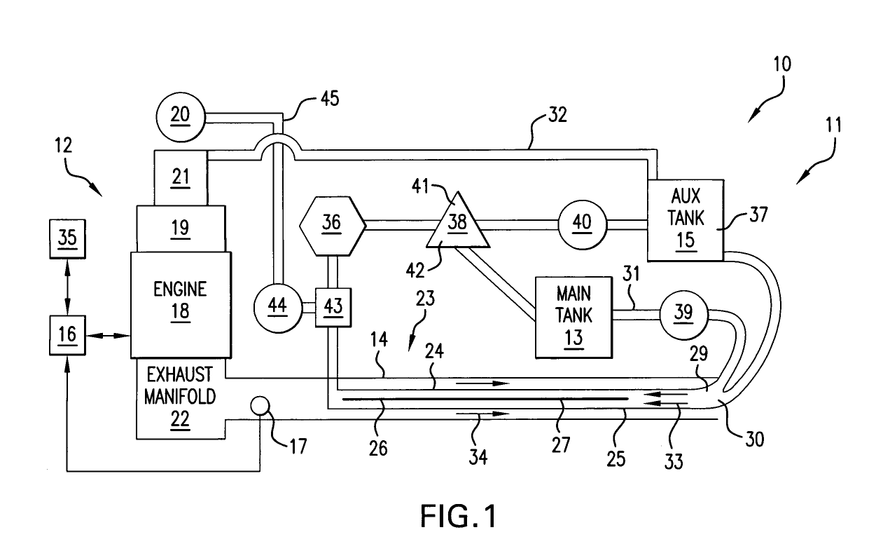

Referring to FIG. 1, an improved pre-ignition fuel treatment system 10 is installed in a motor vehicle 11 having an internal combustion engine 12, a main fuel tank 13, an exhaust pipe 14, an auxiliary fuel tank 15, an engine control module (ECM) 16, and one or more engine/emissions sensor(s) 17. The main fuel tank 13 stores an unreformed hydrocarbon fuel, such as gasoline, that is mixed with a carrier-gas 37 stored in the auxiliary fuel tank 15 to make a fuel-gas mixture 33. Combustion by-products and excess air, collectively referred to as exhaust gases 34, exit from the vehicle to the external atmosphere through the exhaust pipe 14. The engine/emissions sensors 17 monitor the air-to-fuel ratio and/or the amount of oxygen in the exhaust gases 34.

The engine 12 comprises a combustion zone 18, an intake manifold 19, an air filter 20, an LPG (liquefied petroleum gas) carburetor 21, and an exhaust manifold 22. In the combustion zone 18 a fuel-air mixture is combusted and the exhaust gases 34 are expelled into the exhaust manifold 22, which then expels the exhaust gases 34 into the exhaust pipe 14. The combustion process in the combustion zone 18 has the effect of creating a partial vacuum in the intake manifold 19, which draws air from the external atmosphere into the engine 12 through an air filter 20. The air drawn into the intake manifold 19 is mixed with fuel in the LPG carburetor 21 that is located between the air filter 20 and the intake manifold 19. The air-to-fuel ratio produced by the LPG carburetor 21 is controlled by the ECM 16, which is a microprocessor that computes the optimal air-to-fuel ratio based on the readings of the engine/emissions sensor(s) 17.

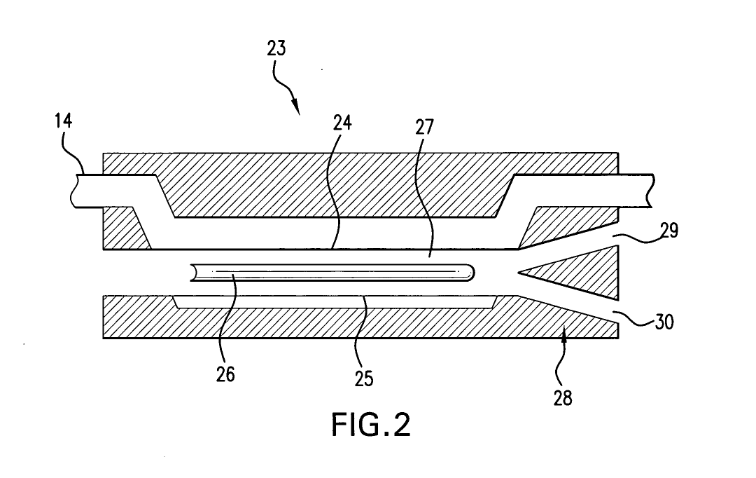

Referring now to both FIG. 1 and FIG. 2, the present invention 10 establishes a multi-pass reaction zone 23 in the exhaust pipe 14 by inserting into a section of the exhaust pipe 14 a reactor vessel 24. The reactor vessel 24 is an oblong plenum formed by a rigid reactor enclosure 25, which is non-contiguously affixed to the exhaust pipe 14. In the preferred embodiment 10, the reactor vessel 24 is a tubular structure fabricated of a material having a high thermal conductivity that can withstand a high temperature, high pressure environment. Optionally, the interior surface of the reactor vessel 24 at its distal end can be textured to increase its area so as to improve heat transfer across the surface. The reactor vessel 24 is axially installed within the exhaust pipe 14 such that the exhaust gases 34 flow around the entire perimeter of the reactor vessel 24. In the preferred embodiment 10, the longitudinal axis of the reactor vessel 24 is aligned with that of the section of exhaust pipe 14 into which it is inserted.

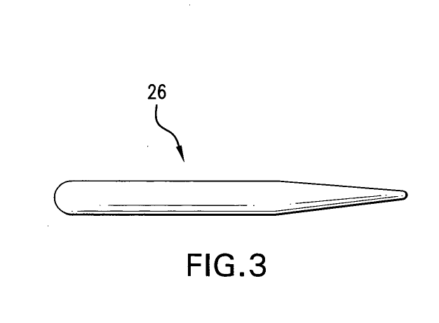

In addition to the reactor enclosure 25, the reactor vessel 24 comprises a reactor rod 26, an annular plenum 27, and an injection assembly 28. The reactor rod 26 is an oblong structure axially positioned within the reactor enclosure 25, such that the annular plenum 27 is formed between the reactor rod 26 and the reactor enclosure 25. In the preferred embodiment, the reactor rod 26 has an elongated cylindrical shape with a convex distal end (i.e., the end furthest from the exhaust manifold 22) and a concave proximal end (i.e., the end closest to the exhaust manifold 22). The diameter of the reactor rod 26 is such that the width of the annular plenum 27 is approximately 1/16 inch. Optionally, the reactor rod 26, can have a slightly tapered diameter in the midsection of the rod. Also optionally, the reactor rod 26 can have a tapered distal side transitioning into a cylindrical proximal side, with both ends being convex, as shown in FIG. 3. The tapered distal end of the latter reactor rod 26 configuration helps reduce turbulence by facilitating a more gradual acceleration of the fuel-gas mixture 33. The length of the reactor rod 26 is in the range of 4 to 12 inches, depending on the type of fuel and the size of the engine 12.

The material composition of the reactor rod 26 is crucial importance to the process of cracking the hydrocarbon fuel and transforming it into a plasma. The reactor rod 26 preferably serves the dual roles of providing a catalyst for the cracking process and participating in the “feedback loop” electromagnetic interaction with ionized fuel molecules, as described hereinabove, which drives the fuel-gas mixture 33 toward a plasma state. In order to fulfill both of these roles, the reactor rod 26 must contain materials that are both highly magnetic and good catalysts for the hydrocarbon cracking process. While the preferred embodiment 10 uses an iron reactor rod 26, other suitable material are steel, nickel, cobalt, rare-earth metals, alloys of the foregoing metals, and magnetic ceramics. Nickel, cobalt and rare-earth metals have known applications as catalysts in hydrocarbon cracking, as disclosed in Cornelius et al., U.S. Pat. No. 4,101,376, Sie, U.S. Pat. No. 4,579,986, and Kumar et al., U.S. Pat. No. 5,248,642, respectively. The reactor rod 26 can also consist of a magnetic core with a catalytic coating or plating. For example, a reactor rod 26 with a steel core covered by a layer of platinum plating is also suitable.

While it is preferable to use a reactor rod 26 having catalytic properties, the present invention 10 does not depend exclusively on a catalytic reactor rod 26. The electrochemical quasi-catalytic reactions promoted by a reactor rod 26 made of a non-catalytic magnetic material are also capable of sustaining the hydrocarbon reformation process.

The shape of the reactor rod 26 is also plays an important role in the cracking and plasma-formation processes. The distal end of the reactor rod 26 has a convex shape, so that the flow of the fuel-gas mixture 33 around the end of the rod is laminar. The goal in forcing the fuel-gas mixture 33 into the constrained annular plenum 27 is to accelerate the flow rate and thereby increase the velocity and kinetic energy of the fuel molecules so that some of them will attain the energy level needed for ionization and cracking to begin. Therefore, turbulent flow around the reactor rod 26 is to be avoided, since turbulence dissipates the molecular kinetic energy and thus retards the ionization and cracking processes. Accordingly, in the preferred embodiment, the proximal end of the reactor rod 26 has a concave shape, which has the effect of creating an area of reduced pressure downstream of the reactor rod 26. This area of reduced pressure has the effect of drawing the flow of fuel-gas mixture 33 evenly along the surface of the reactor rod 26, so that energy-dissipating areas of turbulent flow are avoided.

On the distal end of the reactor vessel 24 is the injection assembly 28, comprising one or more fuel injection port(s) 29 and one or more carrier-gas injection port(s) 30. The fuel injection port(s) are hydraulically connected to a fuel line 31, through which the unreformed hydrocarbon fuel is pumped by a primary pump 39 from the main fuel tank 13. The carrier-gas injection port(s) 30 are pneumatically connected to the auxiliary fuel tank 15, in which is stored the gaseous reformed hydrocarbon fuel 37, which serves as the carrier-gas.

Downstream of the proximal end of the reactor vessel 24, is a condenser 36, in which the fuel-gas mixture 33 is cooled, thereby causing the larger, unreformed hydrocarbon molecules to condense into a liquid phase, while the smaller, reformed hydrocarbon molecules remain in a gaseous phase. The liquid and gaseous phases separate from one another in the liquid-vapor separator 38, which comprises an upper gas chamber 41 and a lower sump chamber 42. The liquid unreformed fuel collects in the sump chamber 42 and is drawn into the main fuel tank 13, which is at lower pressure than the sump chamber 42. The flow of liquid unreformed fuel from the sump chamber 42 to the main fuel tank 13 is controlled by a solenoid valve (not shown) based on the liquid level in the sump chamber 42. From the main fuel tank 13, the unreformed liquid fuel is pumped into the fuel injection port(s) 29 by the primary pump 39, and it is re-circulated through the reactor vessel 24 in multiple passes as many times as it takes to crack it. The reformed gaseous fuel 37 collects in the gas chamber 41, from which a secondary pump 40 pumps it into the auxiliary fuel tank 15.

Between the reactor vessel 24 and the condenser 36 is a hydrogen-mixing manifold 43, in which hydrogen cations (H⁺ ions) are injected into the flow of the fuel-gas mixture 33. The hydrogen cations are generated by an electrolysis cell 44. The hydrogen cations are drawn out of the cathode side of the electrolysis cell 44 by a Venturi injector, which utilizes a partial vacuum created by the flow of the fuel-gas mixture 33 across a Venturi opening or tube. The hydrogen cations combine with the anions of the reformed hydrocarbon fuel plasma to convert the ions into neutral molecules and thereby stabilize the reformed fuel gas. Optionally, the oxygen anions from the anode side of the electrolysis cell 44 can be injected into the engine's air filter 20 through an oxygen inlet 45 in order to improve combustion.

The stabilized reformed fuel gas 37 is then separated from the unreformed liquid fuel by the condenser 36 and the liquid-vapor separator 38, and then it is pumped into the auxiliary fuel tank 15 by the secondary pump 40. From the auxiliary fuel tank 15, some of the stabilized reformed fuel gas 37 is drawn into the intake manifold 19 of the engine 18 through the vacuum conduit 32. Some of the stabilized reformed fuel gas 37 is also injected into the reactor vessel 24 through the carrier-gas injection port(s) 30.

In the present invention 10, unlike that disclosed in application Ser. No. 11/889,226, the partial vacuum of the intake manifold 19 need no longer be used to create a pressure drop across the reactor vessel 24. Instead, the primary and secondary pumps 39 40 create the pressure drop needed to maintain the flow of fuel-gas mixture 33 from the distal to the proximal end of the reactor vessel 24.

The flow direction of fuel-gas mixture 33 through the reactor vessel 24 is in the opposite direction to the flow direction the exhaust gases 34 through the exhaust pipe 14, thus creating a cross-flow that optimizes the transfer to thermal energy from the exhaust gases 34 to the fuel-gas mixture 33. As the fuel-gas mixture 33 is drawn into the reactor enclosure 25 through the injector assembly 28, the cross-flow heats the fuel-gas mixture to the point at which the fuel component is vaporized. As the vaporized fuel-gas mixture 33 enters the annular plenum 27 around the reactor rod 26, its flow path becomes constricted, which causes its pressure and velocity to increase. The increased pressure and kinetic energy of the vaporized fuel-gas mixture 33 is further augmented by its absorption of thermal energy from the exhaust gases, which are becoming progressively hotter as the cross-flow approaches the exhaust manifold 22.

As the fuel-gas mixture 33 flows through the annular plenum 27, the unreformed fuel component undergoes the process of ionization, cracking and plasma-formation described hereinabove. At the proximal end of the reactor vessel 24, hydrogen cations from the electrolysis cell 38 are injected into the fuel-gas mixture 33 in order to stabilize the reformed fuel molecules. The fuel-gas mixture 33 then flows into the condenser 36, where the unreformed liquid fuel is separated from the stabilized reformed gaseous fuel 37, with the former being pumped to the auxiliary fuel tank 15 and the latter being drawn into the main fuel tank 13.

The stabilized reformed gaseous fuel 37 is drawn into the intake manifold 19 through the vacuum conduit 32. At this juncture, the engine control module (ECM) 16 will determine the appropriate air-to-fuel ratio, which will be set either richer (lower ratio) or leaner (higher ratio) based on the readings of the engine/emissions monitor(s) 17. Since, the ECM 16 bases its determination of air-to-fuel ratio on the stoichiometry of conventional fuel (gasoline or diesel) combustion, its operations must be modified to account for the higher energy content of the stabilized reformed gaseous fuel 37 generated by the present invention 10. Therefore, the preferred embodiment of the present invention 10 includes an auxiliary microprocessor 35, which interfaces with the ECM 16 so as to adjust the air-to-fuel ratio to reflect the combustion stoichiometry of the reformed gaseous fuel 37.

An example will illustrate the need for the auxiliary microprocessor 35. Because of the higher energy content of the stabilized reformed gaseous fuel 37, less of it will be consumed to release the same amount of energy as conventional fuel. Therefore, its combustion will consume less oxygen, causing the concentration of oxygen in the exhaust gases 34 to rise. This rise will be reflected in the readings of the engine/emissions sensors 17 and communicated to the ECM 16. Since the ECM 16 does its calculations based on the energy content of conventional fuel, its normal response would be to infer from the rise in oxygen concentration in the exhaust gases that the air-to-fuel ratio is too lean. Therefore, the ECM 16 standing alone would, under the circumstances of this example, signal the engine 12 to increase the concentration of fuel being sent to the combustion zone 18. In so doing, however, the ECM 16 would undo the fuel economy advantage of the stabilized reformed gaseous fuel 37. When the auxiliary microprocessor 35 interfaces with the ECM 16, however, the air-to-fuel ratio is adjusted to account for the higher energy content of the stabilized reformed gaseous fuel 37, thus enabling the present invention 10 to achieve greater savings in fuel consumption.

While this invention has been described with reference to a specific embodiment, the description is not to be construed in a limiting sense. Various modifications of the disclosed embodiment, as well as other embodiments of the invention, will be apparent to persons skilled in the art upon reference to this description. It is therefore contemplated that the appended claims will cover any such modifications or embodiments that fall within the true scope of this invention.

What is claimed is:

1. A method of treating hydrocarbon fuel comprising:
(a) creating a multi-pass reaction zone within a flow of exhaust gases from an internal combustion engine;
(b) inserting within the multi-pass reaction zone a reactor vessel having a proximal end and a distal end, which reactor vessel comprises a reactor enclosure, an injection assembly, a reactor rod, and an annular plenum, wherein the reactor rod is an elongated rod composed of a magnetic catalyst material, or a combination of magnetic and catalytic materials, and wherein the reactor rod is axially disposed within the reactor enclosure and is separated from the reactor enclosure by the annular plenum, and wherein the injector assembly is located at the distal end of the reactor vessel;
(c) establishing a pressure differential between within the reactor vessel, such that the pressure at the proximal end is less than the pressure at the distal end;
(d) introducing into the injection assembly a fuel-gas mixture, which is a mixture of a liquid unreformed fuel component composed of heavier hydrocarbon molecules and a gaseous reformed fuel component composed of lighter hydrocarbon molecules, such that the gaseous reformed fuel component acts as a carrier-gas for the liquid unreformed fuel component, and such that the pressure differential draws the fuel-gas mixture through the reactor vessel from the distal end to the proximal end;
(e) establishing a cross-flow between the exhaust gases and the fuel-gas mixture, wherein the exhaust gases flow around the reactor enclosure from the proximal end to the distal end, while the fuel-gas mixture flows within the reactor enclosure from the distal end to the proximal end;
(f) transferring thermal energy from the exhaust gases to the fuel-gas mixture by means of the cross-flow, such that the rate of thermal energy transfer increases with the increasing temperature of the exhaust gases as the fuel-gas mixture flows toward the proximal end of the reactor vessel;
(g) vaporizing the liquid unreformed fuel component of the fuel-gas mixture with the thermal energy transferred from the exhaust gases as the fuel-gas mixture flows toward the annular plenum, such that the liquid unreformed fuel component becomes a vaporized unreformed fuel component;
(h) drawing the fuel-gas mixture into the annular plenum by means of the pressure differential, and thereby creating a constricted flow, in which the flow velocity, temperature and pressure of the fuel-gas mixture increases, and the hydrocarbon molecules of the vaporized unreformed fuel component attain an elevated energy level;
(i) initiating a cracking of some of the hydrocarbon molecules of the vaporized unreformed fuel component at the elevated energy level at which cracking occurs in the presence of the reactor rod acting as a catalyst, such that the vaporized unreformed fuel component becomes a partially-cracked fuel component having a cracked fuel fraction and an uncracked fuel fraction;
(j) producing from the cracking a plurality of free radicals and ions, which are predominantly anions of the cracked fuel fraction, along with non-ionized molecules of uncracked fuel fraction the partially-cracked fuel component, such that the ions and the non-ionized molecules interact with one another in the constricted flow of the fuel-gas mixture, and energy is transferred back and forth between the ions and the non-ionized molecules;
(k) generating from the constricted flow of the ions an electromagnetic field in and around the reactor rod, thereby magnetizing the reactor rod and causing the reactor rod to develop a magnetic field that exerts a force on the ions;
(l) accelerating the ions by the effect of the force exerted on the ions by the magnetic field, such that the strength of the electromagnetic field is augmented, and such that the kinetic energy of the ions is increased, with some of the increased energy of the ions being transferred to the non-ionized molecules, an increasing proportion of which undergo cracking by attaining the elevated energy level at which cracking occurs in the presence of the reactor rod;
(m) establishing a positive feedback loop in which the electromagnetic field generated by the ions and the magnetic field generated by the reactor rod progressively strengthen each other, thereby progressively increasing the kinetic energy of the hydrocarbon molecules, such that cracking and ionization of the partially-cracked fuel component proceeds to the point that the fuel-gas mixture becomes a plasma;
(n) providing downstream of the reactor vessel a hydrogen mixing manifold, wherein hydrogen cations generated by an electrolysis cell are injected into the fuel-gas mixture, such that the hydrogen cations combine with the anions of the cracked fuel fraction of the partially-cracked fuel component to produce stable, neutral reformed hydrocarbon molecules, which then become part of the gaseous reformed fuel component of the fuel-gas mixture, and such that the fuel-gas mixture becomes an enriched fuel-gas mixture and the gaseous reformed fuel component becomes an augmented gaseous reformed fuel component;
(o) passing the enriched fuel-gas mixture through a condensing means that causes the temperature of the enriched fuel-gas mixture to drop, such that the uncracked fuel fraction of the partially-cracked fuel component condenses into a liquid, which becomes a reconstituted liquid unreformed fuel component, while the augmented gaseous reformed fuel component remains a gas;
(p) passing the enriched fuel-gas mixture into a liquid-vapor separation means to separate the reconstituted liquid unreformed fuel component from the augmented gaseous reformed fuel component;
(q) collecting and storing the reconstituted liquid unreformed fuel component in a main fuel tank;
(r) collecting and storing the augmented gaseous reformed fuel component in an auxiliary fuel tank, from which a portion of the augmented gaseous reformed fuel component is drawn into the internal combustion engine and combusted;
(s) creating a second-generation fuel-gas mixture by mixing a portion of the augmented gaseous reformed fuel component with the reconstituted liquid unreformed fuel component;
(t) introducing the second-generation fuel-gas mixture into the injection assembly of the reactor vessel;
(u) repeating steps (d) through (t), such that the second-generation fuel-gas mixture yields a third-generation fuel-gas mixture, which in turn yields a fourth-generation fuel-gas mixture, and so on until the original liquid unreformed fuel component is completely cracked and becomes part of the augmented gaseous reformed fuel component.

2. The method according to claim 1, wherein the reactor rod is composed of a material selected from the group consisting of iron, iron alloy, steel, steel alloy, nickel, nickel alloy, cobalt, cobalt alloy, rare-earth metals, rare-earth metal alloys, and catalytic magnetic ceramic.

3. The method according to claim 1, wherein the reactor rod comprises a core and an outer layer, such that the core consists of a magnetic material and the outer layer consists of a catalytic material.

4. The method according to either of claims 2 or 3, wherein the reactor road has a distal end which is convex and a proximal end which is concave.

5. The method according to claim 4, wherein the reactor rod is an elongated cylinder.

6. The method according to claim 5, wherein the reactor rod has a tapered midsection.

7. The method according to either of claims 2 or 3, wherein the reactor rod has a tapered distal side transitioning into a cylindrical proximal side, and wherein both ends of the reactor rod are convex.

8. The method according to claim 5, comprising the additional step, prior to combusting the augmented gaseous reformed fuel component in the internal combustion engine, of diluting the augmented gaseous reformed fuel component with air in an air-to-fuel ratio as determined by an engine control module interfacing with an auxiliary microprocessor, such that the auxiliary microprocessor adjusts the air-to-fuel ratio to account for the enhanced energy content of the augmented gaseous reformed fuel component.

9. The method according to claim 6, comprising the additional step, prior to combusting the augmented gaseous reformed fuel component in the internal combustion engine, of diluting the augmented gaseous reformed fuel component with air in an air-to-fuel ratio as determined by an engine control module interfacing with an auxiliary microprocessor, such that the auxiliary microprocessor adjusts the air-to-fuel ratio to account for the enhanced energy content of the augmented gaseous reformed fuel component.

10. The method according to claim 7, comprising the additional step, prior to combusting the augmented gaseous reformed fuel component in the internal combustion engine, of diluting the augmented gaseous reformed fuel component with air in an air-to-fuel ratio as determined by an engine control module interfacing with an auxiliary microprocessor, such that the auxiliary microprocessor adjusts the air-to-fuel ratio to account for the enhanced energy content of the augmented gaseous reformed fuel component.

11. A method of treating hydrocarbon fuel comprising:
(a) creating a multi-pass reaction zone within a flow of exhaust gases from an internal combustion engine;
(b) inserting within the multi-pass reaction zone a reactor vessel having a proximal end and a distal end, which reactor vessel comprises a reactor enclosure, an injection assembly, a reactor rod, and an annular plenum, wherein the reactor rod is an elongated rod composed of a magnetic catalyst material, or a combination of magnetic and catalytic materials, and wherein the reactor rod is axially disposed within the reactor enclosure and is separated from the reactor enclosure by the annular plenum, and wherein the injector assembly is located at the distal end of the reactor vessel;
(c) establishing a pressure differential between within the reactor vessel, such that the pressure at the proximal end is less than the pressure at the distal end;
(d) introducing into the injection assembly a fuel-gas mixture, which is a mixture of a liquid unreformed fuel component composed of heavier hydrocarbon molecules and a gaseous reformed fuel component composed of lighter hydrocarbon molecules, such that the gaseous reformed fuel component acts as a carrier-gas for the liquid unreformed fuel component, and such that the pressure differential draws the fuel-gas mixture through the reactor vessel from the distal end to the proximal end;
(e) establishing a cross-flow between the exhaust gases and the fuel-gas mixture, wherein the exhaust gases flow around the reactor enclosure from the proximal end to the distal end, while the fuel-gas mixture flows within the reactor enclosure from the distal end to the proximal end;
(f) transferring thermal energy from the exhaust gases to the fuel-gas mixture by means of the cross-flow, such that the rate of thermal energy transfer increases with the increasing temperature of the exhaust gases as the fuel-gas mixture flows toward the proximal end of the reactor vessel;
(g) vaporizing the liquid unreformed fuel component of the fuel-gas mixture with the thermal energy transferred from the exhaust gases as the fuel-gas mixture flows toward the annular plenum, such that the liquid unreformed fuel component becomes a vaporized unreformed fuel component;
(h) drawing the fuel-gas mixture into the annular plenum by means of the pressure differential, and thereby creating a constricted flow, in which the flow velocity, temperature and pressure of the fuel-gas mixture increases, and the hydrocarbon molecules of the vaporized unreformed fuel component attain an elevated energy level;
(i) initiating a cracking of some of the hydrocarbon molecules of the vaporized unreformed fuel component at the elevated energy level at which cracking occurs in the presence of the reactor rod acting as a catalyst, such that the vaporized unreformed fuel component becomes a partially-cracked fuel component having a cracked fuel fraction and an uncracked fuel fraction;
(j) producing from the cracking a plurality of free radicals and ions, which are predominantly anions of the cracked fuel fraction, along with non-ionized molecules of uncracked fuel fraction the partially-cracked fuel component, such that the ions and the non-ionized molecules interact with one another in the constricted flow of the fuel-gas mixture, and energy is transferred back and forth between the ions and the non-ionized molecules;
(k) generating from the constricted flow of the ions an electromagnetic field in and around the reactor rod, thereby magnetizing the reactor rod and causing the reactor rod to develop a magnetic field that exerts a force on the ions;
(l) providing downstream of the reactor vessel a hydrogen mixing manifold, wherein hydrogen cations generated by an electrolysis cell are injected into the fuel-gas mixture, such that the hydrogen cations combine with the anions of the cracked fuel fraction of the partially-cracked fuel component to produce stable, neutral reformed hydrocarbon molecules, which then become part of the gaseous reformed fuel component of the fuel-gas mixture, and such that the fuel-gas mixture becomes an enriched fuel-gas mixture and the gaseous reformed fuel component becomes an augmented gaseous reformed fuel component;
(m) passing the enriched fuel-gas mixture through a condensing means that causes the temperature of the enriched fuel-gas mixture to drop, such that the uncracked fuel fraction of the partially-cracked fuel component condenses into a liquid, which becomes a reconstituted liquid unreformed fuel component, while the augmented gaseous reformed fuel component remains a gas;
(n) passing the enriched fuel-gas mixture into a liquid-vapor separation means to separate the reconstituted liquid unreformed fuel component from the augmented gaseous reformed fuel component;
(o) collecting and storing the reconstituted liquid unreformed fuel component in a main fuel tank;
(p) collecting and storing the augmented gaseous reformed fuel component in an auxiliary fuel tank, from which a portion of the augmented gaseous reformed fuel component is drawn into the internal combustion engine and combusted;
(q) creating a second-generation fuel-gas mixture by mixing a portion of the augmented gaseous reformed fuel component with the reconstituted liquid unreformed fuel component;
(r) introducing the second-generation fuel-gas mixture into the injection assembly of the reactor vessel;
(s) repeating steps (d) through (r), such that the second-generation fuel-gas mixture yields a third-generation fuel-gas mixture, which in turn yields a fourth-generation fuel-gas mixture, and so on until the original liquid unreformed fuel component is completely cracked and becomes part of the augmented gaseous reformed fuel component.

12. The method according to claim 11, wherein the reactor rod is composed of a material selected from the group consisting of iron, iron alloy, steel, steel alloy, nickel, nickel alloy, cobalt, cobalt alloy, rare-earth metals, rare-earth metal alloys, and catalytic magnetic ceramic.

13. The method according to claim 11, wherein the reactor rod comprises a core and an outer layer, such that the core consists of a magnetic material and the outer layer consists of a catalytic material.

14. The method according to either of claims 12 or 13, wherein the reactor road has a distal end which is convex and a proximal end which is concave.

15. The method according to claim 14, wherein the reactor rod is an elongated cylinder.

16. The method according to claim 15, wherein the reactor rod has a tapered midsection.

17. The method according to either of claims 12 or 13, wherein the reactor rod has a tapered distal side transitioning into a cylindrical proximal side, and wherein both ends of the reactor rod are convex.

18. The method according to claim 15, comprising the additional step, prior to combusting the augmented gaseous reformed fuel component in the internal combustion engine, of diluting the augmented gaseous reformed fuel component with air in an air-to-fuel ratio as determined by an engine control module interfacing with an auxiliary microprocessor, such that the auxiliary microprocessor adjusts the air-to-fuel ratio to account for the enhanced energy content of the augmented gaseous reformed fuel component.

19. The method according to claim 16, comprising the additional step, prior to combusting the augmented gaseous reformed fuel component in the internal combustion engine, of diluting the augmented gaseous reformed fuel component with air in an air-to-fuel ratio as determined by an engine control module interfacing with an auxiliary microprocessor, such that the auxiliary microprocessor adjusts the air-to-fuel ratio to account for the enhanced energy content of the augmented gaseous reformed fuel component.

20. The method according to claim 17, comprising the additional step, prior to combusting the augmented gaseous reformed fuel component in the internal combustion engine, of diluting the augmented gaseous reformed fuel component with air in an air-to-fuel ratio as determined by an engine control module interfacing with an auxiliary microprocessor, such that the auxiliary microprocessor adjusts the air-to-fuel ratio to account for the enhanced energy content of the augmented gaseous reformed fuel component.

21. An apparatus for treating hydrocarbon fuel comprising:
(a) a multi-pass reaction zone within an exhaust pipe of a vehicle powered by an internal combustion engine, which multi-pass reaction zone has axially disposed within it a reactor vessel;
(b) a reactor vessel having a proximal end and a distal end, which reactor vessel comprises a reactor enclosure, an injection assembly, a reactor rod, and an annular plenum, wherein the reactor rod is composed of a magnetic material, or a catalytic material, or a combination of magnetic and catalytic material, and wherein the reactor rod is axially disposed within the reactor enclosure and is separated from the reactor enclosure by the annular plenum, and wherein the injector assembly is located at the distal end of the reactor vessel;
(c) a fuel-gas mixture, which flows in multiple repeated cycles into the reactor vessel from the injector assembly and then flows through the reactor vessel from the distal end to the proximal end, and which fuel-gas mixture is a mixture of a liquid unreformed fuel component composed of heavier hydrocarbon molecules and a gaseous reformed fuel component composed of lighter hydrocarbon molecules, such that the gaseous reformed fuel component acts as a carrier-gas for the liquid unreformed fuel component, and which liquid unreformed fuel component undergoes an ionization and cracking process in each cycle which progressively transforms the fuel-gas mixture, such that the gaseous reformed fuel component is augmented during each cycle and a portion of the augmented gaseous reformed fuel is combusted in an internal combustion engine.

22. The apparatus according to claim 21, wherein the reactor rod is composed of a material selected from the group consisting of iron, iron alloy, steel, steel alloy, nickel, nickel alloy, cobalt, cobalt alloy, rare-earth metals, rare-earth metal alloys, and catalytic magnetic ceramic.

23. The apparatus according to claim 21, wherein the reactor rod comprises a core and an outer layer, such that the core consists of a magnetic material and the outer layer consists of a catalytic material.

24. The apparatus according to either of claims 22 or 23, wherein the reactor road has a distal end which is convex and a proximal end which is concave.

25. The apparatus according to claim 24, wherein the reactor rod is an elongated cylinder.

26. The apparatus according to claim 25, wherein the reactor rod has a tapered midsection.

27. The apparatus according to either of claims 22 or 23, wherein the reactor rod has a tapered distal side transitioning into a cylindrical proximal side, and wherein both ends of the reactor rod are convex.

28. The apparatus according to claim 25, comprising the additional elements of an engine control module (ECM) digitally interfaced with an auxiliary microprocessor, such that the ECM in concert with the auxiliary microprocessor determines an air-to-fuel ratio which accounts for the enhanced energy content of the augmented gaseous reformed fuel component.

29. The apparatus according to claim 26, comprising the additional elements of an engine control module (ECM) digitally interfaced with an auxiliary microprocessor, such that the ECM in concert with the auxiliary microprocessor determines an air-to-fuel ratio which accounts for the enhanced energy content of the augmented gaseous reformed fuel component.

30. The apparatus according to claim 27, comprising the additional elements of an engine control module (ECM) digitally interfaced with an auxiliary microprocessor, such that the ECM in concert with the auxiliary microprocessor determines an air-to-fuel ratio which accounts for the enhanced energy content of the augmented gaseous reformed fuel component.
